(19) United States
(12) Patent Application Publication
(10) Pub. No.: US 2005/0229763 A1
(43) Pub. Date: Oct. 20, 2005

(54) Pre-biasing device for urging movable member relative to fixed base

(76) Inventor: Xiao Alan, Taichung City (TW)

Correspondence Address: CHARLES E. BAXLEY, ESQ., 90 JOHN STREET, THIRD FLOOR, NEW YORK, NY, 10038, US

(21) Appl. No.: 10/828,035

(22) Filed: Apr. 20, 2004

(51) Int. Cl. A01D 69/10; B23D 19/04

(52) U.S. Cl. 83/508.2; 83/507

(57) ABSTRACT

A pre-biasing device includes a bolt which threadedly extends through a connection member and is connected to the movable member which is slidably matched with the fixed base. A plurality of springs are mounted to the bolt and are biased between the connection member and the movable member so as to apply a pre-set force to bias the movable member to the fixed base. The movable member is less likely to shake by the pre-set biasing force.

### FIELD OF THE INVENTION

The present invention relates to a pre-biasing device for applying a pre-set force to a movable member which is slidably engaged with rails of a fixed base of a grinder.

### BACKGROUND OF THE INVENTION

A conventional grinder is disclosed in FIGS. 1 and 2, and generally includes an upright post 10 along which a movable member 20 is slidably engaged. The movable member 20 is connected to a grinding wheel 22 so as to move in Y-axis direction. A worktable is oriented in X-axis direction and can also be moved in Z-axis direction. The post 10 includes two inclined rails 11 and the movable member 20 has two wings each of which has an inclined surface 21 so as to be slidably matched with the inclined rails 11. A positioning member 30 is connected to a rear end of the post 10 and fixed to the movable member 20 by bolts 31. In order to allow the movable member 20 to be moved up and down, a gap about 0.01 to 0.02 mm is defined between the positioning member 30 and the movable member 20. However, if a large feeding is required, the movable member 20 tends to shake and cannot maintain the precise grinding result.

The present invention intends to provide a pre-biasing device that employs bowl-like springs to apply a pre-set force to the movable member relative to the fixed base so as to reduce shaking of the movable member.

### SUMMARY OF THE INVENTION

The present invention relates to a pre-biasing device for urging a movable member to a fixed base. The fixed base has two inclined rails in a vertical direction and the movable member is slidably engaged with the two inclined rails. The movable member has two inclined surfaces which are slidably matched with the two inclined rails. The pre-biasing device comprises a connection member connected to a rear end of the movable member and a plurality of bolts extend through the connection member and are connected to the movable member. Each bolt has a plurality of springs mounted thereto which are biased between the connection member and the movable member and so as to provide a force to maintain the movable member not to shake.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional grinder;

FIG. 2 is a cross sectional view to show the movable member, the fixed base and the connection member in the conventional grinder;

FIG. 3 is a cross sectional view to show the movable member, the fixed base, the connection member and the pre-biasing device of the present invention;

FIG. 3-1 shows the bowl-shaped springs used in the pre-biasing device of the present invention;

FIG. 4 is a cross sectional view to show another embodiment of the pre-biasing device of the present invention;

FIG. 5 is a cross sectional view to show yet another embodiment of the pre-biasing device of the present invention;

FIG. 5-1 shows an enlarged cross sectional view of the pre-biasing device of the present invention;

FIG. 6 is an exploded view to show that the pre-biasing device is cooperated with two wedge-shaped members;

FIG. 7 is a cross sectional view to show the pre-biasing device cooperated with two wedge-shaped members;

FIG. 8 shows that the bolt is threadedly moved to push the upper wedge relative to the fixed wedge;

FIG. 9 shows the pre-biasing device is cooperated with a wedge which is clamped between a movable member and a fixed base, and

FIG. 10 shows that the wedge in FIG. 9 is moved by threadedly moving the bolt of the pre-biasing device.

### DETAILED DESCRIPTION OF THE PREFERRED EMBODIMENT

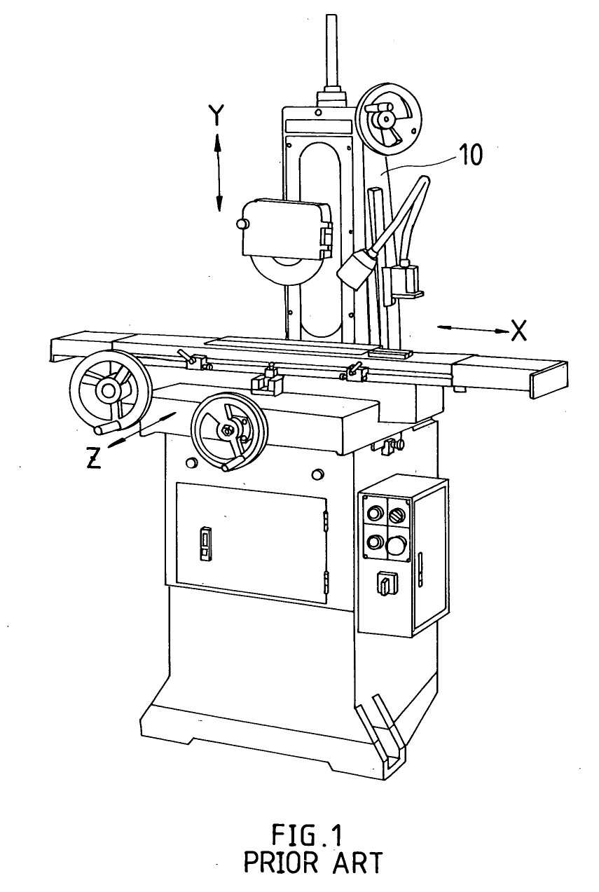

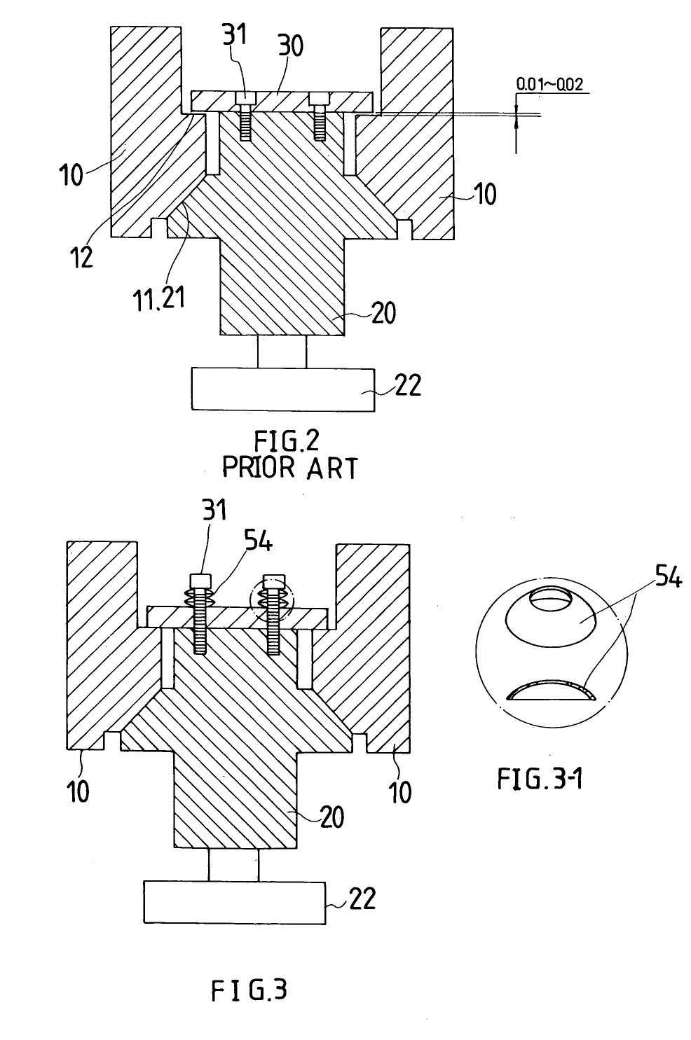

Referring to FIGS. 3 and 3-11, the pre-biasing device of the present invention is utilized in a grinder which comprises a movable member 20 and a grinding member 22 is connected to the movable member 20. The movable member 20 is moved relative to a fixed base 10 in Y-axis direction as defined in FIG. 1. The fixed base 10 has two inclined rails in the Y-axis direction and the movable member 20 is slidably engaged with the two inclined rails 11. The movable member 20 has two inclined surfaces 21 which are slidably matched with the two inclined rails 11.

The pre-biasing device comprises a connection member 30 which is connected to a rear end of the movable member 20 and a plurality of bolts 31 extend through the connection member 30 and are connected to the movable member 20. Further referring to FIG. 3-1, each bolt 31 has a plurality of springs 54 mounted thereto which are bowl-shaped springs. The springs 54 provide a pre-set force applied to the movable member 20 so that the movable member 20 is not likely to shake during operation.

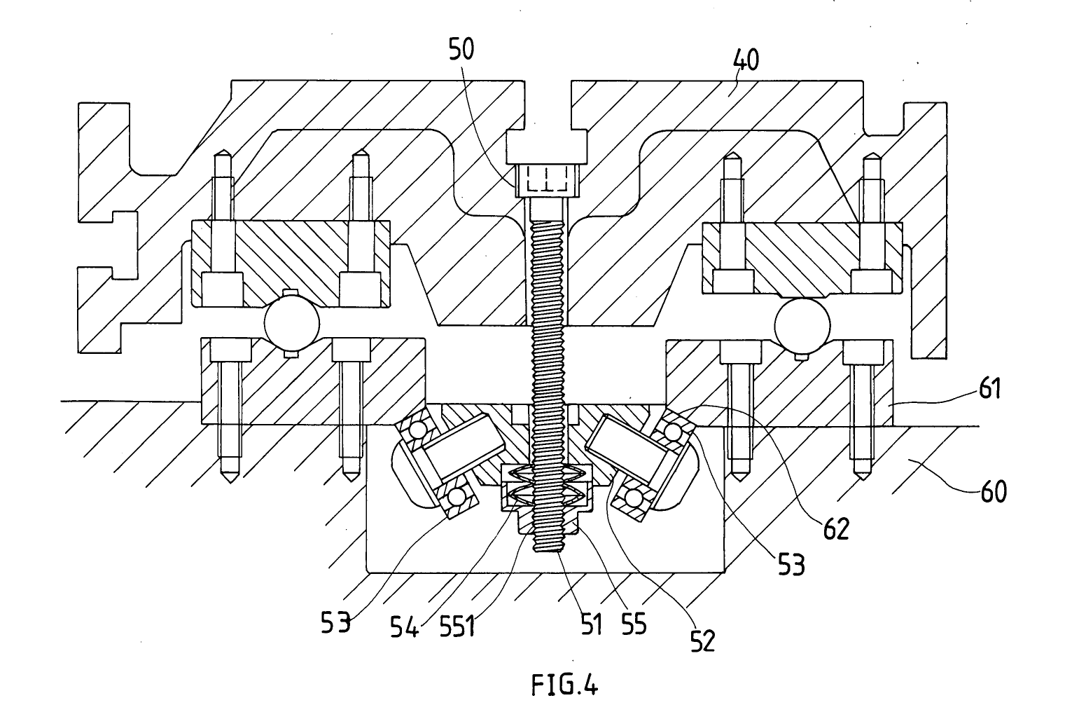

FIG. 4 shows that the pre-biasing device is used with another type of grinder which includes a movable member 40 which is movably mounted to a fixed base 60 in a horizontal direction. The fixed base 60 includes two guide members 61 on the horizontal direction and each guide member 61 has an inclined rail 62. The movable member 40 is slidably mounted to a top of the two guide members 61.

The pre-biasing device used in the grinder in FIG. 4 comprises a bolt 50 which extends through the movable member 40 and is threadedly connected to an operation member 52 which his movably received in a groove defined in the fixed base 60. The connection member 52 has two rollers 53 which are matched with the two inclined rails 62. A cap 55 has a threaded passage 551 and the bolt 50 is threadedly connected to the threaded passage 551. A plurality of bowl-shaped springs 54 are mounted to the bolt 50 and biased between the connection member 52 and the cap 55.

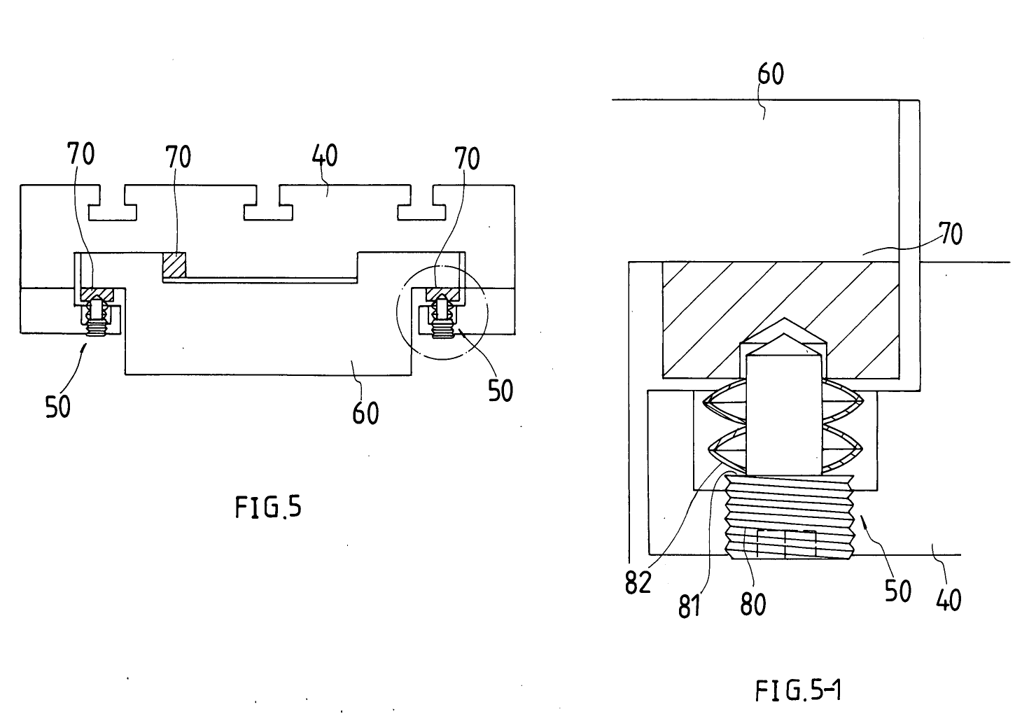

FIGS. 5 and 5-1 show that the pre-biasing device is used with another type of grinder which includes a movable member 40 to a fixed base 60. The fixed base 60 has two wings and the movable member 40 is slidably mounted on a top surface of the fixed base 60. The movable member 40 has two extensions which are located beneath the two wings of the fixed base 60. Each of the two extensions has a durable piece 70 connected thereto and slidably in contact with the wing corresponding thereto. The pre-biasing device comprises a bolt 80 which threadedly extends through each of the extensions of the movable member 40 and is connected to the durable piece 70. Each bolt 80 has a shoulder surface 81 and a plurality of bowl-shaped springs 82 are mounted to the bolt 80. The springs 82 are biased between the shoulder surface 81 and the durable piece 70.

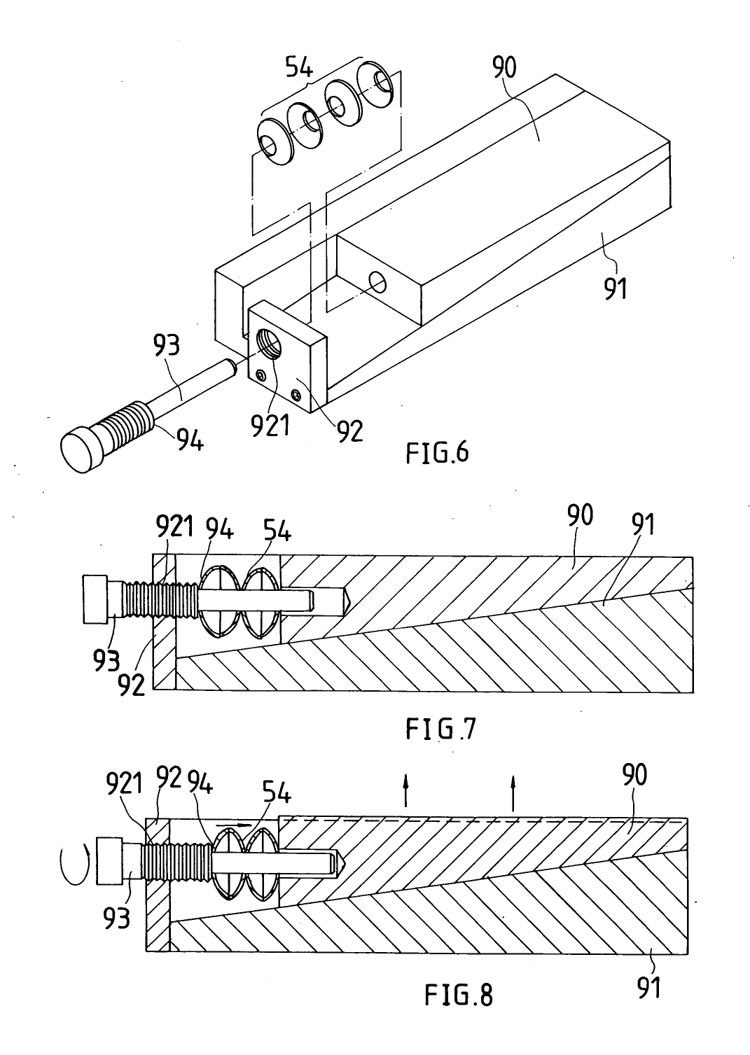

FIGS. 6 to 8 show that the pre-set biasing device can be used with an upper movable wedge member 90 and a lower fixed wedge member 91. The movable wedge member 90 has an inclined side which is movably matched with an inclined side of the fixed wedge member 91. The fixed wedge member 91 includes an end wall 92 which has a threaded hole 921 and the bolt 93 is threadedly extended through the threaded hole 921 and a distal end of the bolt 93 is movably inserted in a hole in the movable wedge member 90. A plurality of bowl-shaped springs 54 are mounted to the bolt 93 and biased between a shoulder surface 94 on the bolt 93 and an end surface of the movable wedge member 90. Therefore, the user may rotate the bolt 93 to adjust the springs 54 to apply a force to the movable wedge member 90 which exerts a force on the fixed wedge member 91.

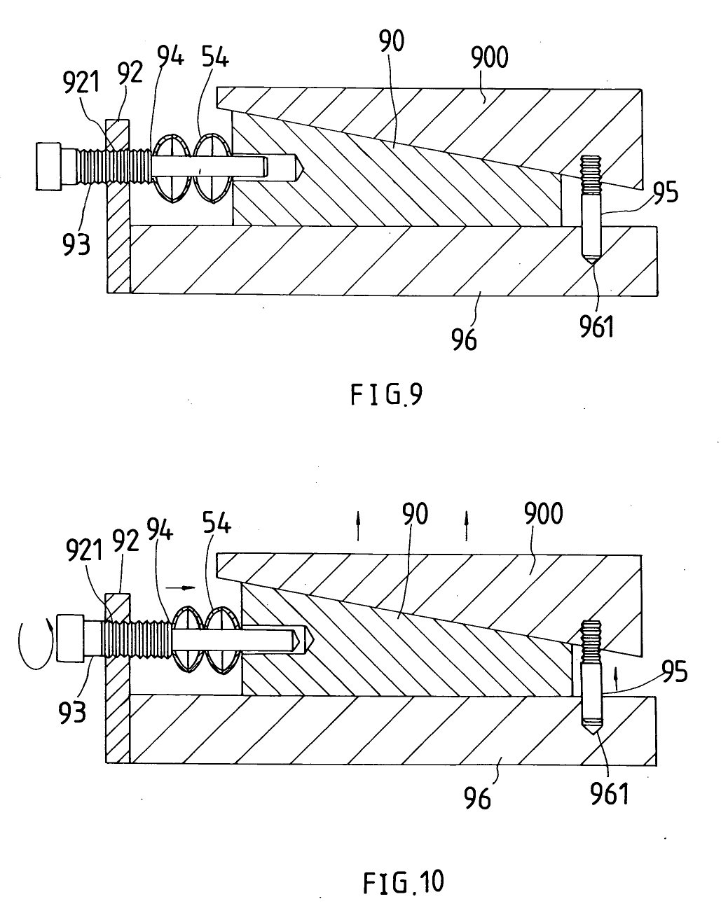

FIGS. 9 and 10 show that a wedge member 90 is clamped between a movable wedge member 900 and a fixed base 96 which has a horizontal top surface and the wedge member 90 has a flat horizontal bottom matched with the horizontal top surface of the fixed base 96. The movable wedge member 900 has an inclined surface that is matched with an inclined top surface of the wedge member 90. A pin 95 has one end threadedly connected to the movable wedge member 900 and the other end of the pin 95 is movably inserted in a recess 961 defined in the horizontal top surface of the fixed base 96. The fixed base 96 has an end wall 92 which has a threaded hole 921 and the bolt 93 is threadedly extended through the threaded hole 921 and a distal end of the bolt 93 is movably inserted in a hole in the wedge member 90. A plurality of bowl-shaped springs 54 are mounted to the bolt 93 and biased between a shoulder surface 94 on the bolt 93 and the wedge member 90. The movable wedge member 900 moves close to or away from the fixed base 96 by threading the bolt 93.

While we have shown and described the embodiment in accordance with the present invention, it should be clear to those skilled in the art that further embodiments may be made without departing from the scope of the present invention.

1. A pre-biasing device for urging a movable member to a fixed base, the fixed base having two inclined rails in a vertical direction and the movable member slidably engaged with the two inclined rails, the movable member having two inclined surfaces which are slidably matched with the two inclined rails, the device comprising:
a connection member adapted to be connected to a rear end of the movable member and a plurality of bolts extending through the connection member and adapted to be connected to the movable member, each bolt having a plurality of springs mounted thereto.

2. The device as claimed in claim 1, wherein the springs are bowl-shaped springs.

3. A pre-biasing device for urging a movable member to a fixed base, the fixed base including two guide members on a horizontal direction and each guide member having an inclined rail, the movable member slidably mounted to a top of the two guide members, the device comprising:
a bolt adapted to extend through the movable member and threadedly connected to an operation member, the connection member having two rollers which are adapted to be matched with the two inclined rails, a cap having a threaded passage which is threadedly connected to the bolt, a plurality of springs mounted to the bolt and biased between the connection member and the cap.

4. The device as claimed in claim 3, wherein the springs are bowl-shaped springs.

5. A pre-biasing device for urging a movable member to a fixed base, the fixed base having two wings and the movable member slidably mounted on a top surface of the fixed base and having two extensions which are located beneath the two wings of the fixed base, each of the two extensions having a durable piece connected thereto and slidably in contact with the wing corresponding thereto, the device comprising:
a bolt adapted to threadedly extend through each of the extensions of the movable member and to connect the durable piece, each bolt having shoulder surface and a plurality of springs mounted to the bolt, the springs having one end biased the shoulder surface and the other end of the springs adapted to bias the durable piece.

6. The device as claimed in claim 5, wherein the springs are bowl-shaped springs.
